(19) United States
(12) Patent Application Publication
(10) Pub. No.: US 2011/0196769 A1
(43) Pub. Date: Aug. 11, 2011

(54) System and Method for Determining Optimal Financial Risk Positions for Finance Issuers

(75) Inventor: Peter Orr, Brooklyn, NY (US)

(73) Assignee: INTUITIVE ANALYTICS, LLC, Brooklyn, NY (US)

(21) Appl. No.: 13/025,514

(22) Filed: Feb. 11, 2011

Related U.S. Application Data
(60) Provisional application No. 61/303,651, filed on Feb. 11, 2010.

(51) Int. Cl. G06Q 40/00

(52) U.S. Cl. 705/35

(57) ABSTRACT

The system and method of the present invention provide optimization techniques and methodologies for utilization by finance issuers (especially those in the public finance sector), that create liability-based financing solutions within the context of market variables modeled using stochastic methods, or equivalents thereof. Various embodiments of related systems and methods are also provided.

### CROSS REFERENCE TO RELATED APPLICATIONS

The present patent application claims priority from the commonly assigned co-pending U.S. provisional patent application No. 61/303,651 entitled “System and Method for Determining Optimal Financial Risk Positions for Finance Issuers”, filed Feb. 11, 2010.

### FIELD OF THE INVENTION

The present invention relates generally to a system and method for obtaining optimal liability and financial risk positions for finance issuers, and more particularly to a data processing system and method for determining optimal liability structures and risk exposures for finance issuers (especially in the public sector—e.g., for public finance entities managing capital market risks), given a combination of current market data, market forecasts, and financing constraints.

### BACKGROUND OF THE INVENTION

The United States public finance industry broadly involves the raising of capital for public entities for a variety of public purposes. Public finance issuers include administrative, governmental, and municipal entities such as states, cities, counties, school districts, public housing agencies, public utilities, airport and other transportation authorities. Public finance principles also apply to not-for-profit entities like public universities, healthcare systems and hospitals, and cultural institutions like museums (hereinafter, collectively “Issuers”).

In each of the past five years, roughly $430 billion in tax-exempt securities were issued in the public finance sector. Issuers sell bonds to fund projects that are generally deemed to satisfy some public purpose such as transportation, public safety, sanitation, energy delivery, health and other social services. Usually, these Due to the long useful lives of the projects financed (roads, bridges, jails, airports, hospitals, etc), these bonds have similarly long final maturities, usually 20 to 30 years, but even up to 40. A variety of considerations are involved in structuring a new financing or re-financing including availability of bank letters or lines of credit, bond insurer capacity and cost efficiency, existing debt, rating agency sensitivities, future borrowing needs, and appetite for capital market risks.

Debt service is the generic term in public finance for principal and interest payments that result from issued bonds and other debt. Ultimately, the principal amortization and resulting debt service of a bond issue is frequently determined through the use of commercially available municipal bond structuring software packages. The functionality of these products is usually limited to creating a particular aggregate or net debt service “shape” using bond structures that investors find at least somewhat attractive in the market. This amortization structure is generated based upon user defined market inputs regarding bond prices as well as other parameters such as project cost, costs of issuance, insurance, and reserve fund size.

There are many significant shortcomings of these types of widely available bond structuring software. First, they do not provide for a meaningful analysis of interest expense that varies, i.e. bonds with periodic interest rate resets (“variable rate” or “floating rate” bonds) or any of its associated forms. Specifically, the user is forced to assume a static interest rate in each period the bonds are outstanding; essentially forcing them to be calculated as fixed rate bonds. Second, they do not allow for the meaningful analysis of derivative structures which are now commonplace in public finance. Third, and as an adjunct to the first two points, no risk elements are incorporated into the solution, particularly cash flow risk which is fundamental in public finance. And last and very importantly, since the software doesn't include relevant risk measures, the net effects of natural (other on balance-sheet risks) or derivative hedges are excluded from the financial structuring solution.

Over the last decade, the use of floating rate debt has increased dramatically and along with it, the use of swaps and other derivatives. Therefore, current software products in industry do not offer the ability to meaningfully analyze these structures, not to mention assets such as cash which might provide a natural hedge for certain risks. This deficiency frequently leads to a misunderstanding of risk and ultimately, suboptimal financial decisions and liability structures.

By way of example, the functionality of existing public finance solutions are usually limited to creating a particular aggregate or net debt service “shape” based solely upon the issuer's existing debt profile and budgetary objectives. This amortization structure is generated based upon user defined market inputs regarding bond prices and coupons and the solution type.

A number of standard industry solutions to bond structuring problems are shown in FIGS. 8-10. For example, assume an issuer wants to structure a $100 million bond issue to be repaid over 20 years. Expected revenues to fund this debt are shown by the top line starting at $8 million and growing linearly to nearly $14 million over the next 20 years. A “level” debt service solution at the top of FIG. 8 creates equal aggregate principal and interest payments in each of the 20 years of the bond issue. A “proportional” solution creates a debt service pattern which scales geometrically with the revenue constraint; in this case debt service is about 77% of the revenue constraint in each year. At the top of FIG. 9, a “uniform” solution reflects an equal dollar difference between the revenue constraint and the annual debt service schedule. At the bottom of FIG. 9, debt service is “accelerated” so it is paid off as quickly as possible within the revenue constraint. At the top of FIG. 10, debt service is “deferred” and all the principal is paid in the last years of the repayment schedule. At the bottom of FIG. 10, a “fill” solution reflects the issuance of debt to completely absorb the revenues. In this structure, more than $100 million is raised for projects. Total revenues support a bond issue totaling more than $129 million. Other solution examples might include equal principal payments in each year or some combination of all of the above within different time periods.

There a number of material shortcomings of these types of widely available bond structuring software. First, they do not provide for a meaningful analysis of interest expense that varies, i.e. bonds with periodic interest rate resets (“variable rate” or “floating rate” bonds) or any of its associated forms. Specifically, the user is forced to assume a static interest rate in each period the bonds are outstanding; essentially forcing them to be calculated as fixed rate bonds. Second, they do not allow for the analysis of non-trivial derivative structures which are now commonplace in the market. Third, and as an adjunct to the first two points, no risk elements are incorporated into the solution, particularly cash flow risk which is fundamental in public finance. And last and very importantly, since the software doesn't include relevant risk measures, the net effects of natural or derivative hedges are excluded from the financial structuring solution.

An article germane to the inventive system and method showing the “state of the art” in municipal liability management was written in April, 2004 by Goldman Sachs (Goldman Sachs' Research, Municipal Liability Management, April 2004). In it, they describe the municipal liability management process and its relation to traditional corporate liability management. Regrettably, the article misses a number of critical points. Corporate debt tends to be issued as bullet maturities, closely tied to on-the-run Treasury rates. The problem of how principal amortizes and hence creates a sequence of (stochastic) budgetary liabilities is not a primary focus. Thus, Goldman has not clearly delineated the problem.

This is further demonstrated by the illustration in the article of fixed rate debt and its variability. The mark to market variability of an issuer's debt profile is more often than not, an afterthought for the public finance officer.

The Goldman Sachs Municipal Liability Management paper describes the steps of this process as follows:
Market Topography (1) Generate thousands of realistic and probability weighted market scenarios through time incorporating interconnections among markets
Cashflow Simulation (2) Calculate each cash flow/mark-to-market associated with each asset/liability instrument across each market scenario through time.
Strategy Selection (3) Identify areas of improvement and determine the set of appropriate structured product, restructuring, and/or derivative strategies
Constrained Optimization (4) Optimize among the set of selected strategies to compute the efficient frontier and identify key liability management transactions
Tactical Considerations (5) Analyze regulatory, accounting, and other tactical issues beyond those already incorporated in the strategic analysis

Note that in the description above, Steps 3-4 are treated as separate and distinct; strategy selection and constrained optimization. In contrast, this invention combines those two steps specifically selecting structures and optimizing in one step (See FIG. 1). Further, as a financial structuring package, this invention should be used, at minimum each time a new financing is considered and any time markets move in a material way. The GS article recommends using their program at a different time and obviously accomplishing a different objective, “We recommend a full update of the analysis for each budgetary planning cycle.”

The horizons contemplated by available capital market risk management software are also too short for public finance issuers. By virtue of the public entity's fundamental nature as a going concern, public bodies have a uniquely long term perspective, and must manage risk accordingly. A recent article published by JPMorgan called, Beyond Fixed Floating: Introducing a Dollar Based Risk Metric for Municipal Finance, details this reality. Software such as that created by RiskMetrics is not designed for 30+ year's analysis and in fact, their documentation says as much. In the LongRun technical document on pg 3, “Whereas the RiskMetrics methodology is geared toward measuring market risks for short-term horizons, up to approximately 3 months, LongRun handles longer-term market risk up to 2 years.” Two years doesn't approach the required decision making horizon for most public debt issuers which may extend to 40 years.

Additionally, products like RiskMetrics provide no financial structuring capability on the liability side relevant for tax-exempts, in part because of the horizon limitation mentioned above. The steps involved in the RiskMetrics LongRun methodology are as follows (pg. 2-3 LongRun Technical Document):
STEP 1: Defining risk. Define the type of financial risk we plan to measure. In other words, do we want to measure future changes in “marked-to-marker” value, cashflow amount, reported earnings, or other?
STEP 2: Cashflow identification and mapping. Given the definition of value in Step 1, identify all cash flows whose values are subject to change and allocate those cash flows to a price series, where the price series will determine the risk of the cash flows.
STEP 3: Forecasting. Specify a set of future (forecast) dates and obtain the joint distribution of these prices at each of the dates.
STEP 4: Scenario simulation. Obtain the position's distribution of potential changes in value. We generate market prices and rates scenarios and then value the positions at each of these scenarios.
STEP 5: Risk estimation. Calculate a risk measure (e.g. VaR) given the positions' distribution of potential changes in value.

Optimization software such as Palisade's RISKOptimizer is advertised to solve stochastic optimization problems. However, these types of packages do not have any of the financial functions required to generate valuations, cash flows, and ultimately performance within the problem construction described above. If even possible, it would take significant effort to build the requisite financial functionality into these types of generic tools.

It would thus be desirable to provide a system and method for utilizing optimization techniques and methodologies that create liability-based financing solutions, within the context of market variables modeled using stochastic methods.

### BRIEF DESCRIPTION OF THE DRAWINGS

In the drawings, wherein like reference characters denote corresponding or similar elements throughout the various figures:

FIG. 1 is a simple flowchart overview of the steps involved in the inventive system and method;

FIG. 2 at the top is a graph of 100-trial simulations of tax-exempt floating rates (BMA) and at the bottom is the same information shown with the average rate in the top simulation shown by the black dot at each point in the simulation, and red and blue errorbars showing 1 to 2 standard deviations from the mean in the upper and lower direction respectively;

FIG. 3 at the top is a graph of 100-trial simulations of the relationship between tax-exempt/taxable short term rates (the BMA/LIBOR ratio) and at the bottom is the same information shown with the average rate in the top simulation shown by the black dot, and red and blue errorbars showing 1 to 2 standard deviations from the mean in the upper and lower direction respectively;

FIG. 4 at the top is a graph of 100-trial simulations of taxable floating rates (the London Interbank Offered Rate or “LIBOR”) and at the bottom is the same information shown with the average rate in the top simulation shown by the black dot, and red and blue errorbars showing 1 to 2 standard deviations from the mean in the upper and lower direction respectively;

FIG. 5 at the top shows a representation of a 3 dimensional matrix of (rows X columns X panels) time steps X number of simulations X number of market variables, called “m” in the remainder of this disclosure. At the bottom is shown a 3 dimensional matrix of time steps X number of simulations X functions of market elements representing financial instruments such as derivatives, investments, or assets, called “f” or “f(m)” throughout this disclosure;

FIG. 6 at the top shows a representation of a 3 dimensional matrix of time steps X number of simulations X notional amounts of bonds or derivatives, called “N” throughout this disclosure. At the bottom is shown a 3 dimensional matrix of time steps X number of simulations X time increments in years, called “t” throughout this disclosure;

FIG. 7 at the top shows a representation of a 3 dimensional matrix of time steps X number of simulations X cashflows for each structure, called “C” or “Ct” throughout this disclosure. At the bottom is shown a 3 dimensional matrix of time steps X number of simulations X principal payments on bonds in number of market elements, called “P” throughout this disclosure;

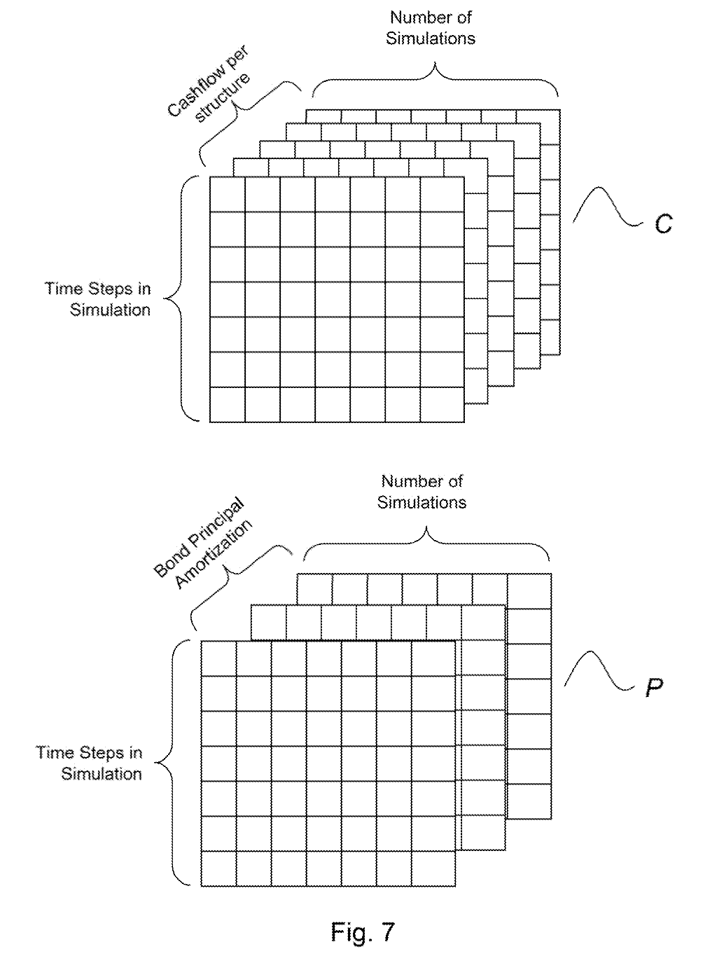

FIG. 8 at the top shows a “level” principal and interest bond solution to a $100 million issue. At the bottom is shown a “proportional” principal and interest bond solution;

FIG. 9 at the top shows a “uniform” principal and interest bond solution to a $100 million issue. At the bottom is shown an “accelerated” principal and interest bond solution; and

FIG. 10 at the top shows a “deferred” principal and interest bond solution to a $100 million issue. At the bottom is shown a “fill” proportional principal and interest bond solution.

### SUMMARY OF THE INVENTION

The system and method of the present invention remedy the disadvantages of previously known systems and methods by providing optimization techniques and methodologies for utilization by finance issuers (especially those in the public finance sector), that create liability-based financing solutions within the context of market variables modeled using stochastic methods, or equivalents thereof.

Advantageously, in various exemplary embodiments thereof, the inventive system and method provide different novel techniques for operating at least one data processing system to determine at least one optimum financial liability structure (e.g., for example for use by finance issuers) based on: (1) multiple financial data inputs, (2) at least one financial factor, and (3) at least one predefined constraint. In the broadest exemplary embodiment of the present invention, the novel system and method are preferably implemented in at least one data processing system, that is operable, in accordance with the present invention, to perform at least the steps of:
(a) providing multiple financial data inputs;
(b) providing at least one predefined constraint;
(c) identifying at least one stochastic financial factor from the at least one stochastic factor;
(d) assigning at least one predetermined distribution to the at least one stochastic financial factor; and
(e) determining the at least one optimum financial liability structure based at least in part on the multiple financial data inputs, the at least one predefined constraint, and the at least one predetermined distribution.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### DETAILED DESCRIPTION OF PREFERRED EMBODIMENTS

The system and method of the present invention remedy the disadvantages of previously known systems and methods by providing optimization techniques and methodologies for utilization by finance issuers (especially those in the public finance sector), that create liability-based financing solutions within the context of market variables modeled using stochastic methods, or equivalents thereof.

It should be noted that while the various exemplary embodiments of the inventive system and method are described with reference to public finance issuers and related applications, the novel and advantageous inventive principles and techniques disclosed herein can be readily configured, adapted, and/or applied to solve similar problems and challenges in other financial sectors without departing from the spirit of the present invention.

The inventive system and method can be used very broadly for those involved in issuing debt in the capital markets, particularly those in public finance. Also, inventive system and method can be incorporated into existing software technology utilized in the appropriate financial sectors (for example, such as RiskMetrics or DBC Finance) to add much-needed functionality and intuition both to risk management analyses, and new financing structures. Other parties that would readily benefit from utilizing the inventive system and method, include, but are not limited to, financial software providers particularly those serving the public finance community, rating agencies, professional investors, investment banks, financial advisors, and public finance issuers.

The implications for banks in particular, and for the way their public finance businesses are organized, are far-reaching. Currently, public finance investment banking groups tend to use very different analytic tools than their colleagues on derivative desks or in quantitative research. The investment bank structuring analysts use industry standard software or perhaps custom spreadsheet models. Both will often employ some optimization routine to achieve the goals of the financing. The inventive system and method bridge this gap and can be used by both derivative professionals and investment bank structuring analysts.

Before describing the various exemplary embodiments of the present invention in greater detail, it would be useful to provide a formulation of one of the primary problems solved by the inventive system and method. As described above, a fundamental assumption currently required in solving the liability structuring problem is that interest rates on floating rate bonds be essentially “fixed” or at least follow a single deterministic path throughout the life of the instrument. The inherent stochastic nature of the problem is “assumed away.” Generally, the system and method of the present invention relaxes this assumption, assigns a specific distribution to those factors that are stochastic and then determines the resulting optimum liability structure based upon user inputs and constraints. This leads to many advantageous, novel, unexpected, and practical results.

### Problem Formulation

The debt service payments made during each budget period (usual annual) can be described in a straightforward way, though abstract for many participants in the municipal marketplace. This abstraction points to an optimization problem(s) however which sheds new light on the challenges faced by tax-exempt entities managing their debt, derivatives, and assets for that matter. During each (budget) time period, call it t, cash flows from the issuer can be described as

$${C}_{i} = {P}_{i} + {\sum }_{i = 1}^{n} {N}_{i} {f}_{i} ( {m}_{i} )$$

where Cₜ is cashflow during budget time t (though t could be a single point in time as well), Pₜ is principal paid at or during time t, and N and f are notional amounts and functions of market variables respectively. In matrix notation this looks even more compact,

Cₜ=Pₜ+N^{T}ƒ(mₜ)
N in this situation is a column vector of notional amounts and f(mₜ) is a column vector of rate payoff functions for either bonds or derivatives. For purposes of the equations and in order to keep things a bit “cleaner,” we assume N is already scaled by the periodicity of the bonds or derivatives i.e. monthly, quarterly, semi-annual, etc.

In the tax-exempt market, short term interest rates are represented by the Bond Market Association Municipal Swap Index (“BMA”). In the taxable money markets, the benchmark index is the London Interbank Offered Rate (“LIBOR”). These two indices and the relationship between the two drive the vast majority of the cashflow volatility inherent in tax-exempt issuers' debt portfolios. Therefore, examples of f include, but are not limited to the following:

| | |
|---|---|
| Fixed Rate Bonds | fᵢ(m) = Coupon (a scalar like .05) |
| Tax-exempt Floaters | fᵢ(m) = BMA (+support costs) |
| BMA Swap | fᵢ(m) = SwapRate − BMA |
| LIBOR Swap | fᵢ(m) = SwapRate − LIBOR (or % LIBOR) |
| Basis Swap | fᵢ(m) = % LIB − BMA |
| BMA cap | fᵢ(m) = max(0, BMA-Strike) |
| BMA floor | fᵢ(m) = min(0, BMA-Strike) |
| Cash earnings | fᵢ(m) = LIBOR |

In the examples above, f is a function of market variables BMA and LIBOR though these are simply representative. The fixed income derivative markets have developed a wide variety of pricable fs and continue to innovate daily. Further, there are no theoretical limits to the size and range of market variables in m. Of course, practical computational limitations apply. BMA and LIBOR are chosen to illustrate the points because, as previously mentioned, the vast majority of cash flow risks in public finance are reflected by changes in these two rates.

Now that Cₜ is defined, we see that since m reflects market variables that have some random nature (i.e. they are “stochastic”), functions of m that generate Cₜ itself result in a stochastic variable which has an expectation, E[Cₜ], and a variance, Var[Cₜ]. One simple goal for our Cₜ might be to minimize both expectation and variance. However, this may go too far down the path of defining risk for an entity, and in a somewhat trivial way. Absolute variation may not be a concern. Rather, a tolerance may exist for great cashflow volatility as long as capital cost doesn't exceed a fixed percent, say 6%. Or perhaps, an entity doesn't want to exceed 6% with 95% confidence. Since Cₜ is a random variable, if modeled properly we should be able to develop a full distribution of Cₜ for each relevant point in time or in aggregate for complete multi-period budgeting.

A number of key results spring from this formulation relating to how one can manipulate the distribution of Cₜ. There are basically three items: the amount of principal due in the period, P, the notional amount of bonds or derivatives in the period, N, or the types of derivative or bond functions, f. These are essentially the degrees of freedom in the problem. This formulation leads to many questions, the answers for which current industry standard software provides little if any insight:
1. What amount of BMA variable rate exposure in a period generates the minimum volatility for Cₜ? It is likely non-zero if BMA/LIBOR basis exposure or cash earning LIBOR based returns exist on the balance sheet.
2. What principal amounts in a new bond amortization keep overall expected debt service “level”? What about level at a 90% confidence level?
3. How much BMA/LIBOR basis swap risk would offset existing BMA variable rate exposure?
4. What combination of BMA variable rate and BMA/LIBOR basis exposures leads to the minimum expected cost?
5. What amount of cash (earning LIBOR) would provide the best expected hedge to an existing debt and derivative portfolio?
6. For a new financing, what combination of new debt and derivative structures are the most cost and risk effective structures on a stand-alone basis or within the context of an existing portfolio?
7. What impact on a debt portfolio would result from a change in the expected correlation between BMA and LIBOR? What adjustments would be made in order to minimize risk in the event this change occurs?

The inventive system and method preferably require a reasonably large amount of input information. A natural categorization of inputs and outputs might fall into these categories:

Inputs
Existing Bonds—Enter current debt structure
Existing Cashflow Risks—Enter derivative and other financial instrument information
Existing Assets—Enter cash, fixed income, other investment positions
New Bonds—Enter current market information, prices/yields
New Cashflow Risks—New derivative structures available in the market
Scenarios—Enter specification of user defined alternatives
RateModel Specs—Enter parameters for rate simulations
AssetModel Specs—Enter simulation parameters for asset returns
OutputSelections—Select outputs to be displayed by user
Advanced—Enter

Outputs
Generic Outputs
Scenario/Optimization Outputs

The user interface could take a variety of forms, may be Internet based or implemented, perhaps in a preferred embodiment, in a spreadsheet program such as Microsoft Excel™ given its prevalence across businesses. The above inputs and outputs may be individual “sheets” within a spreadsheet file.

### Simulation

First, a simulation of relevant market factors must be made, preferably capturing the expected covariance structure of these factors. For many state and local governmental issuers it may suffice to employ a two factor model. A generalized mean reverting stochastic differential equation (SDE) that lends itself readily to simulating short term interest rates is

drₜ=aₜ(mₜ−rₜ)dt+rₜ^{a}σₜdZₜ
where drₜ is the instantaneous change in a short term interest rate such as BMA or LIBOR (a “short rate”), mₜ is the average rate to which simulated rates in the model revert (not to be confused with m the market set, aₜ is the reversion speed at time t, and a is a scaling parameter which controls how much the volatility of the model is dependent upon rates. With a=1 the model displays lognormal volatility which is a market convention for vanilla caps and swap options (“swaptions’). The volatility parameter, σₜ can be a scalar constant, a deterministic function of t, or even driven by another stochastic function.

For purposes of simulating rates, the SDE must be discretized. A discrete version of the model is:

Δrₜ=aₜ(mₜ−rₜ₋₁)Δt+rₜ₋₁^{a}σₜ\sqrt{Δt}·zₜ

We assume dZₜ is a discrete increment of a Brownian motion and zₜ is an independent Gaussian random variable with 0 mean and unit variance (zₜ˜N(0,1)). Thus giving a natural way to simulate short rates:

rₜ₊₁=rₜ+aₜ(mₜ−rₜ)Δt+rₜ^{a}σₜ\sqrt{Δt}·zₜ

This type of model is ideal for analyzing path dependent structures where the cumulative probability of certain events occurring is an important result. In fact, any analysis where cumulative totals or results are the goal can be effectively explored with this model. Simpler alternatives might involve the user entering an expectation for short rates and then creating a distribution from that expectation at each point in time based upon an estimated probability distribution function and its appropriate parameterization. Given the market's tendency to display wide swings more frequently than the normal distribution might suggest, other extensions might include having zₜ distributed as a Student T or multi-normal distribution. Yet another refinement might include a Milstein scheme implementation which would preclude negative interest rates and speed convergence.

Other asset classes, most likely encountered among not-for-profit healthcare or higher education institutions, can be modeled in a number of different ways. A preferred embodiment will reflect the covariance structure of the assets with the short rates modeled above. In general a model might take the following form:

dSₜ=a(Sₜ,t)dt+b(Sₜ,t)dZₜ

A straightforward embodiment might employ a constant drift term, μ, and constant volatility term, σ:

dSₜ=μSₜt+σSₜdZₜ

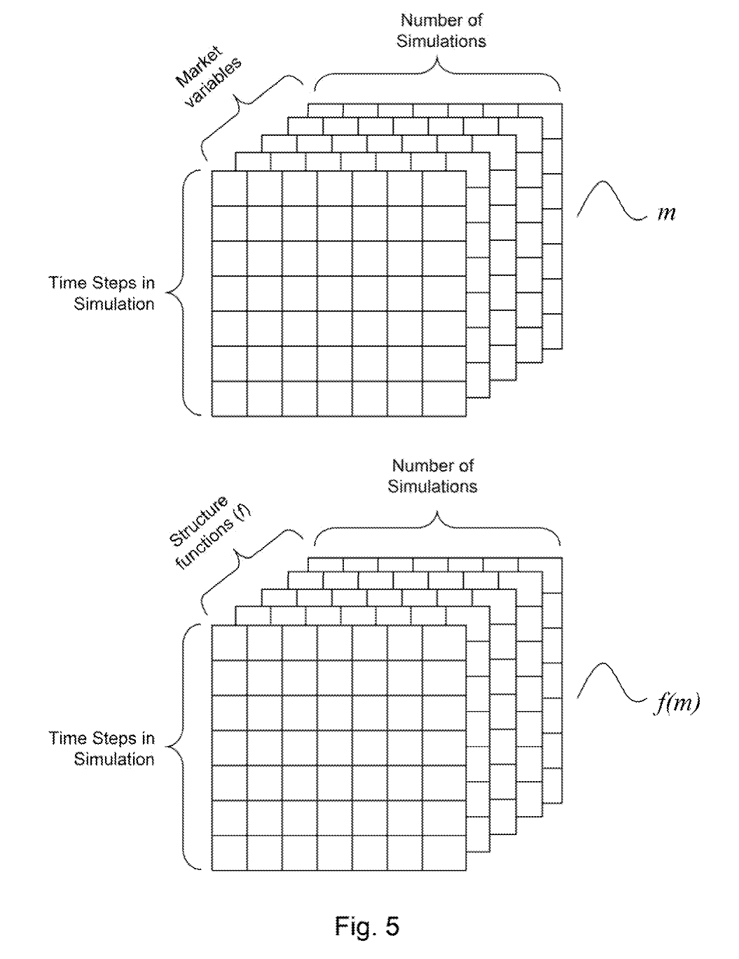

With these simulations complete, a full 3 dimensional array of results can be manipulated. Such an array, m, is graphically shown at the top of FIG. 5. Each matrix or “panel” represents a different market element within m. It shows the simulation number (n)x time step array of numbers where further points in time go from top to bottom and different simulation paths are structured to go across column by column from 1 to n. The first row of each matrix is the initial rate or price for that market variable within the simulation.

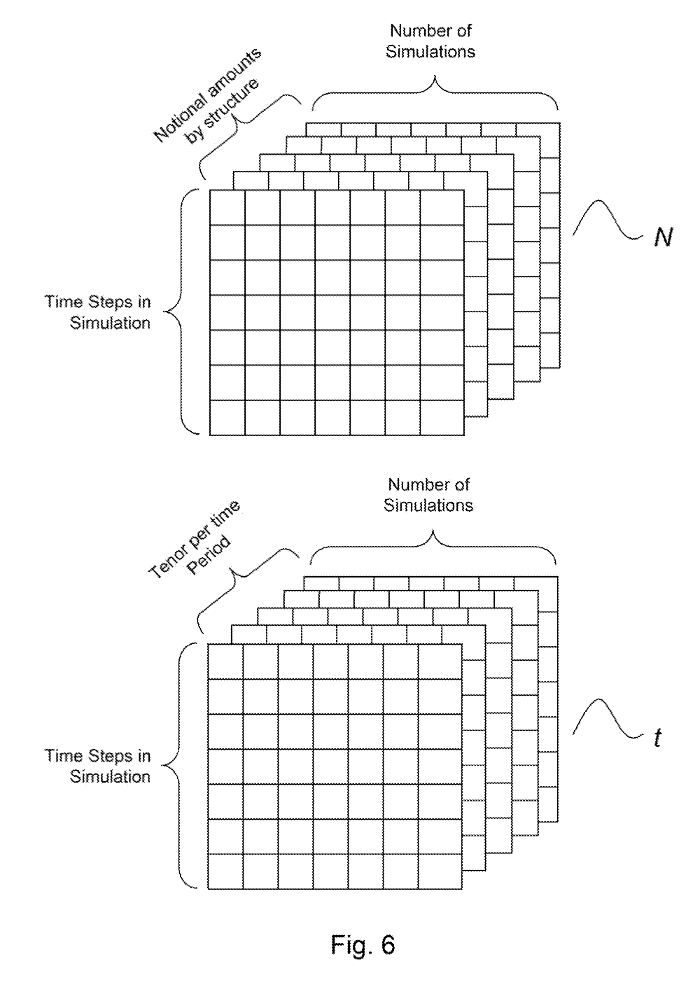

With m in hand, we can now evaluate the cash flows and/or mark to market changes from actual liability, asset, or derivative structures as reflected by f(m) (see bottom of FIG. 5). In order to derive cashflow projections for interest rate derivatives we usually need to scale f(m) by the both the tenor of each cashflow and the amount of the exposure as reflected by the principal or notional amount, t and P represent these three dimensional arrays in FIG. 6. Recall the formula above,

Cₜ=Pₜ+N^{T}ƒ(mₜ)

In order to establish dollar returns on assets film) needs to be scaled by the amount of the holding in each period.

### Optimization Solutions

The description to this point has been of an embodiment of a methodology for simulating market variables and calculating the cashflow or mark to market impact of those simulations and forecasts through f(m). These types of calculation are described in many places including the RiskMetrics technical documents referenced above. The novel and non-obvious extension of these calculations is in the use of single and multi-objective optimization algorithms to actually solve for the principal or notional amounts of liability structures to minimize cumulative or periodic Cₜ, Var[Cₜ], or almost countless other cost, return, or risk statistics possible within this construction.

For example, assume an issuer has $20 million in cash that, on average, it expects to have in the bank every year for the next 20 years. Next, they need to raise $100 mm through the issuance of bonds and the question arises as to how much variable rate debt to issue out of the $100 mm. This type of question is raised repeatedly in the public finance markets and occurs frequently in corporate finance more generally. With a simulation of BMA, LIBOR and their resulting expected distributions at each future payment date, multi-objective optimization routines can be used to find the solution.

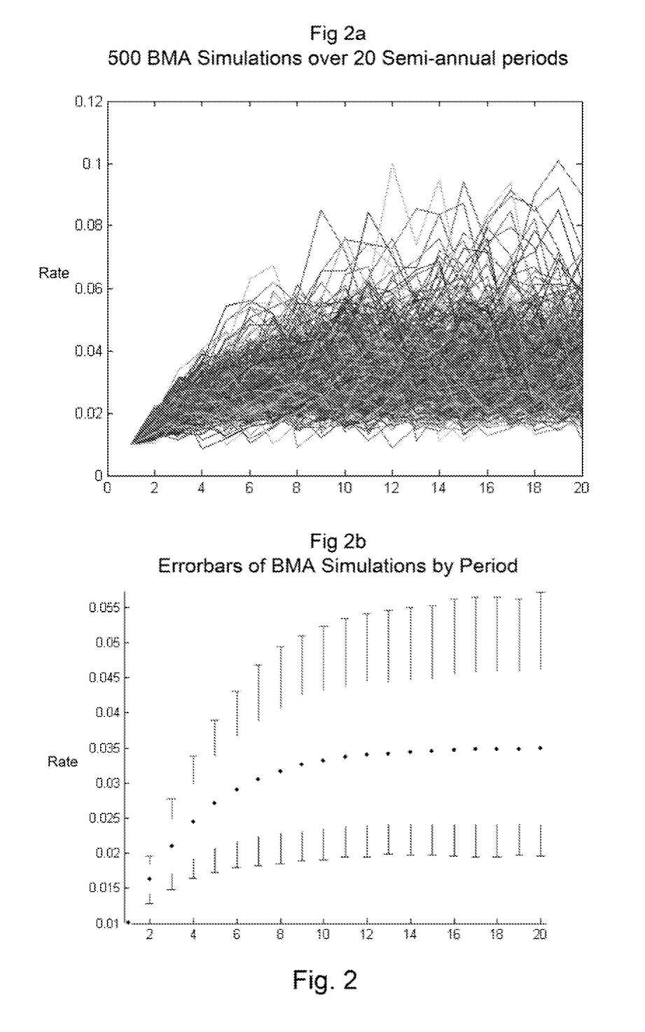

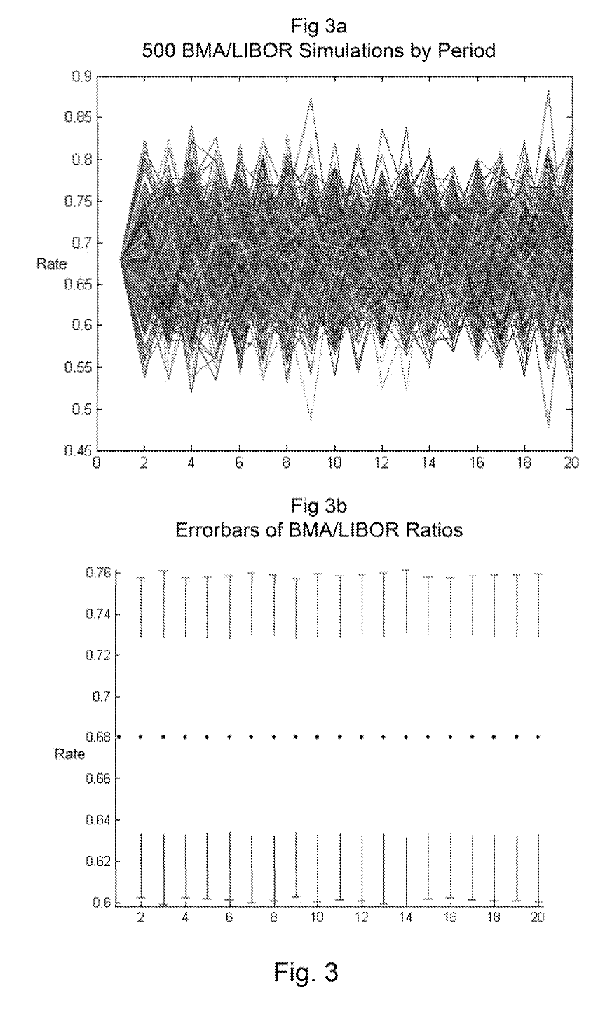

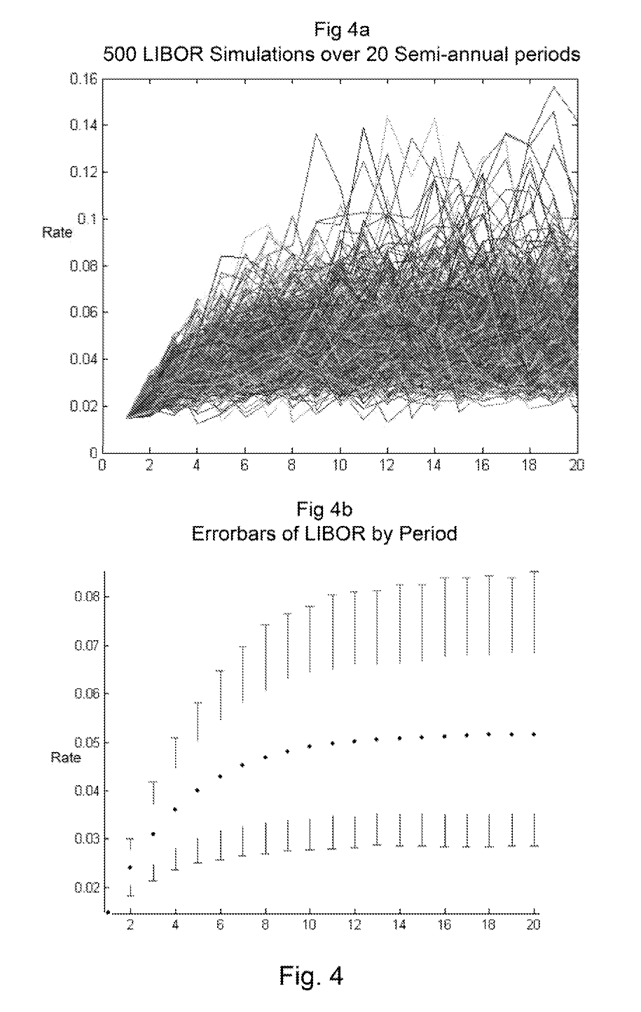

Referring now to FIG. 2, the BMA is shown simulated semi-annually over 20 years. FIG. 3 shows an average of the BMA/LIBOR ratio modeled over the same time frame. The BMA rates in FIG. 2 divided by the BMA/LIBOR ratios in FIG. 3 yield the simulation for LIBOR itself shown in FIG. 4.

With these simulations in place, the true variability in debt service expense and financial performance is captured, offering the ability to create “optimal” structures. Possible objective functions for an optimization include, but are not limited to:
Expected periodic or total average capital cost
Expected periodic or total total/present value interest expense
Expected periodic or aggregate cashflow standard deviation
95% (or other) confidence Cashflow At Risk (95% highest minus mean)

To this non-exhaustive list of objective functions, many constraints must be added. Often, in addition to funding a project from bond proceeds, the costs of issuing the bonds are built into the size of the issue. These costs are often a function of the par of the issue, or total debt service, and as such, create a bond sizing solution that's recursive. For instance, costs of issuance may be 1% of the total par and bond insurance may be 2% of total debt service. Also; for marketing purposes there may be minimum requirements for bonds in particular maturities etc. These many constraints must be included for the solution to ultimately be valid.

Mathematically, a general nonlinear optimization problem can be constructed as follows:

$${min}_{x} g ( x ) subject to$$

$$b ( x ) \leq 0$$

$$ceq ( x ) = 0$$

$$A \cdot x \leq b$$

$$Aeq \cdot x = beq$$

$$lb \leq x \leq ub$$

where x, b, beq, lb, and ub are vectors, A and Aeq are matrices, c(x) and ceq(x) are function that return vectors, and g(x) is a function that returns a scalar. Applied to the problem formulated above, g(x) is likely some function of Cₜ such as E[Cₜ], Var[Cₜ], or Cₜ at some confidence level. The x might be the principal amount of certain bonds, P, the notional amount of swaps and derivatives, N, or the structure of certain functions, f. Depending upon the selection of the x or independent variable, many different constraints may apply.

In summary, the system and method of the present invention include, but are not limited to the following advantages:
(1) First Mover product—A crossover method which is “the first and only asset/liability management and financial structuring software in the public finance market.”
(2) Productivity—Saves significant amounts of time and analytic energy leading to productivity improvements within investment banks and other financial service firms
(3) Addresses well established need—With interest rates going up and the greater use of floating rate bonds and derivatives, many issuers are looking for new ways to calculate and manage liability risks
(4) In front of a trend—Financial engineering has been brought only narrowly to the public finance arena through investment banks but has received very positive reception and greater demand
(5) Speed—Given the matrix formulation of the problem, computational speed is very fast.
(6) Ease of use—Target user groups require nothing more than a basic understanding of statistics. No knowledge of hedging is required even though results are often reflecting these concepts
(7) Educational—Helps teach capital market functioning and derivative pricing by using market models for rates and prices
(8) Novel—The inventive system and method provide for financing solutions without the previously required assumption that certain stochastic market variables follow a deterministic path. This provides for the incorporation of risk measures in a financing solution in a way previously not contemplated and incorporates structures previously not possible
(9) Difficult to design around—Required skill sets include programming, public finance bond structuring, financial engineering, derivative markets, linear and non-linear, single and multi-objective optimization techniques
(10) Excitement—will grab spotlight attention as many people are naturally intrigued by new first mover products
(11) Compatibility—the preferred embodiment likely uses existing spreadsheet software as a front end and as such, allows for incorporation of existing models or easy expandability
(12) Significant market exists—Over $400 billion tax-exempt securities issued in each of the last three years
(13) Answers simple questions in a powerful consistent way without requiring an advanced degree by the user

The vast majority of public finance issuers are exposed to some degree of floating rate debt or other cash flow risks. Almost by definition, these risks involve stochastic elements. The idea that the slow, risk-averse world of public finance could benefit from the “rocket science” of stochastic calculus and optimization is an idea that's over due. It hasn't been considered previously both because of an assumed lack of sophistication of the marketplace and a misunderstanding of the broad applicability of the concepts.

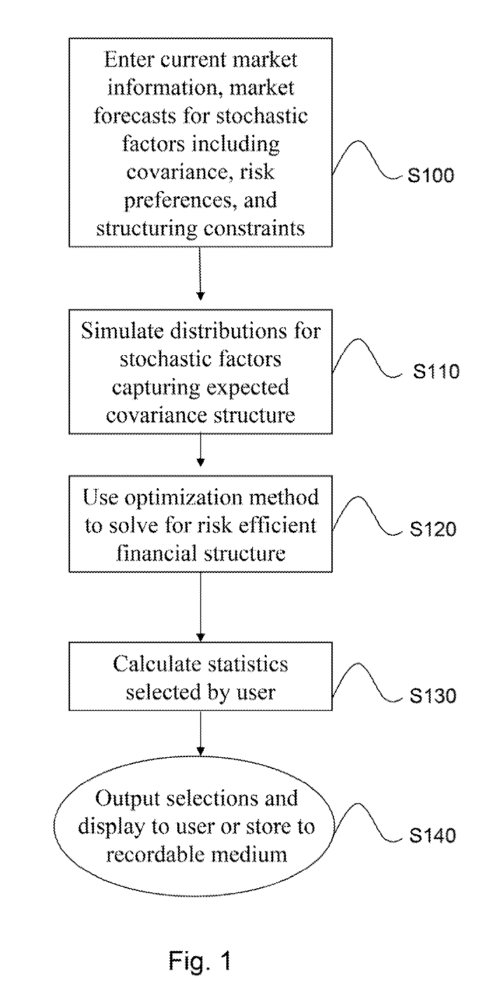

By way of example, the first exemplary embodiment of the inventive system and method requires the user to input parameters sufficiently detailed to generate the market set m, across different points in time (see S100-S110 of FIG. 1 and FIGS. 2-4 for a sample m). The modeling for the distribution of these may employ any number of different types of well known analytic, Monte Carlo or other numerical methods. One possible form for the required distribution of short term rates is

drₜ=aₜ(mₜ−rₜ)dt+rₜ^{a}σₜdZₜ
where drₜ is the instantaneous change in a short term interest rate such as BMA or LIBOR (a “short rate”), mₜ is the average rate to which simulated rates in the model revert, aₜ is the reversion speed at time t, and a is a scaling parameter which controls how much the volatility of the model is dependent upon rates. With a=1 the model displays lognormal volatility which is a market convention for vanilla caps and swap options (“swaptions’). The volatility parameter, σₜ may be a scalar constant, a deterministic function of t, or even driven by another stochastic function.

As described previously, the most important market elements for generating distributions of debt service expense for a tax-exempt entity are a short term tax-exempt rate (usually the BMA index), a taxable short term rate (usually LIBOR) and the ratio between the two (the BMA/LIBOR ratio). A model generating such distributions should capture the features of these rates as much as possible and generally, very low interest rates (below 3% LIBOR) have historically tended to occur alongside particularly high BMA/LIBOR ratios.

With these market variables in hand, the user inputs information regarding the pricing/structure of potential new derivatives or bonds from which the inventive system and method will generate certain results or “solutions” (see S120 of FIG. 1).

As previously described, cash flows at a particular point in time or over a budgetary period can be expressed according to the following formula:

Cₜ=Pₜ+N^{T}ƒ(mₜ)

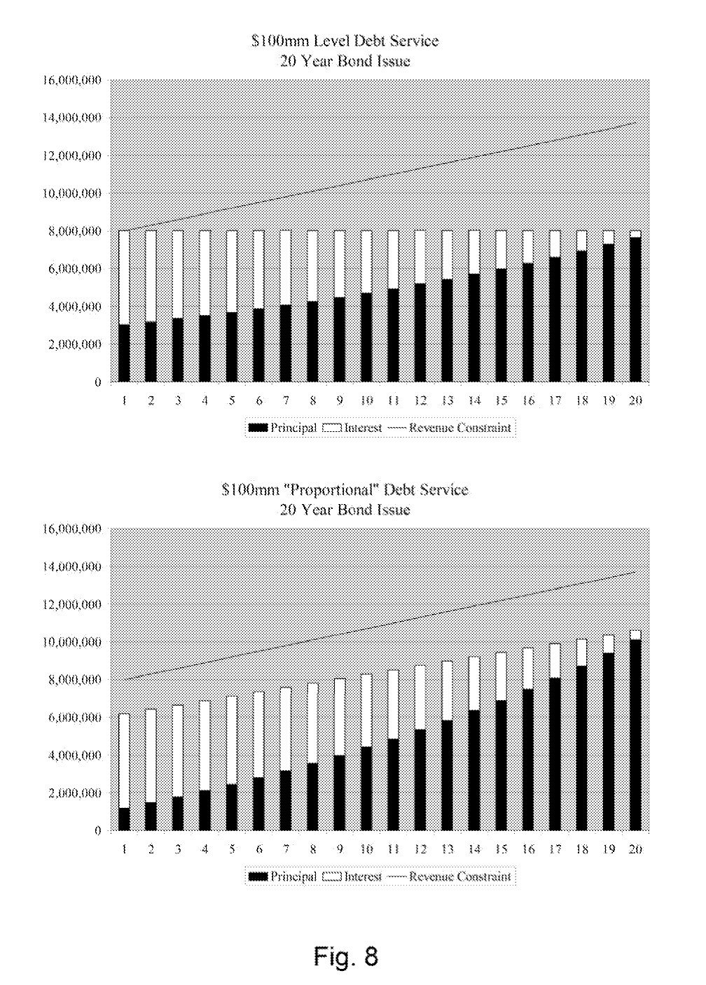

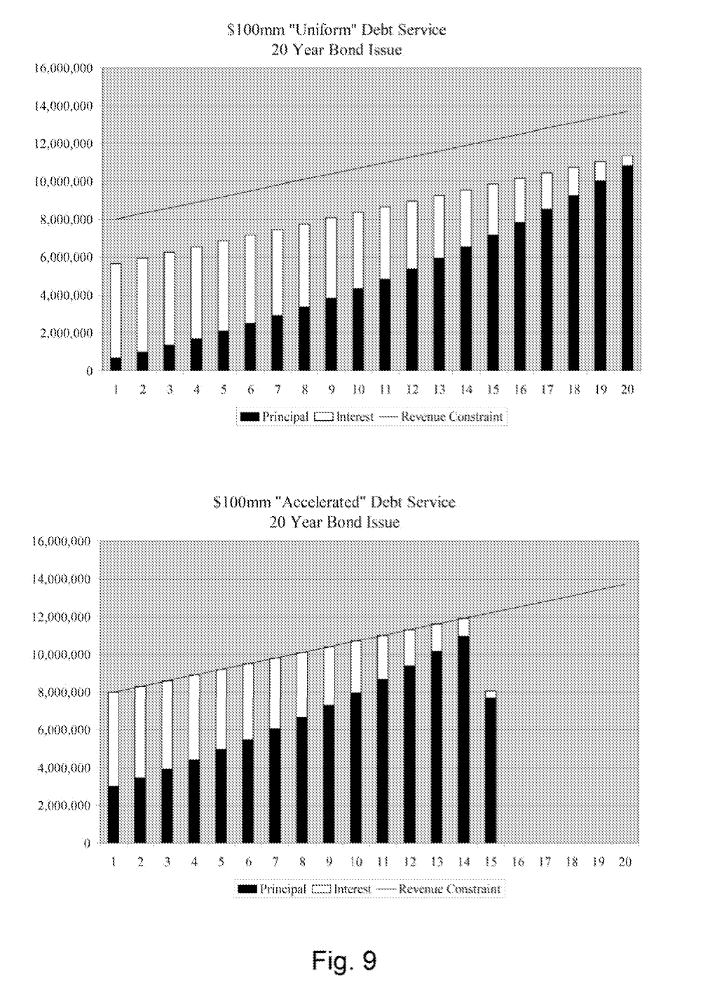

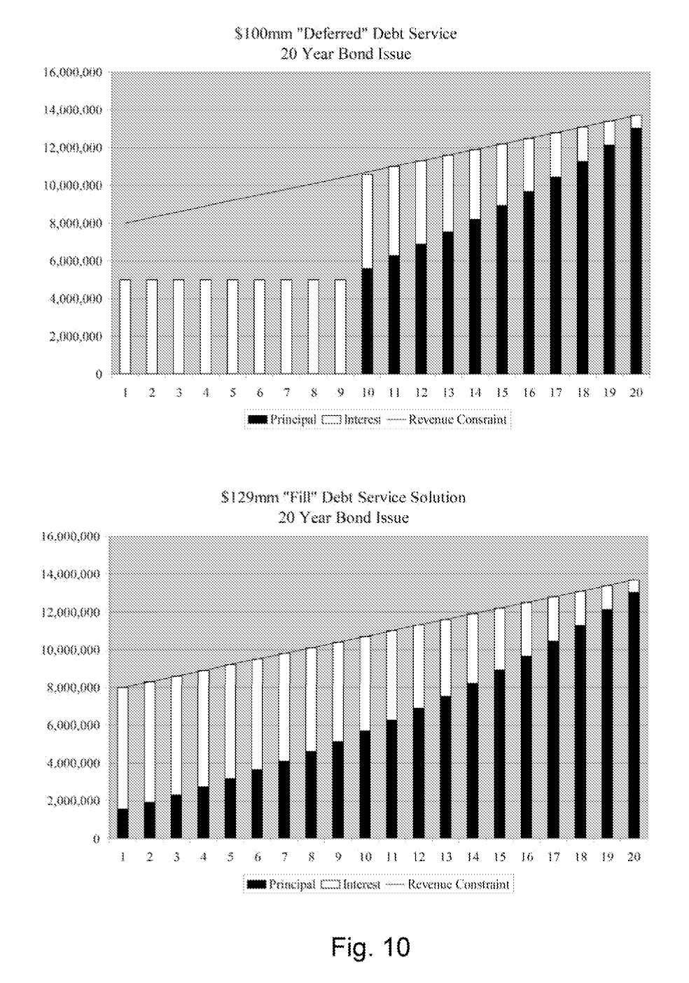

With m simulated either through an analytic or numerical method, linear and nonlinear optimization techniques are employed to achieve a variety of objectives. From the above formula, the independent variable x could be P, N, or f. Thus the user can solve for principal amounts, notional amounts, or actual functions (i.e. derivative structures) that best achieve the financial goals of the entity.

$${min}_{x} g ( x )$$

$$subject to$$

$$b ( x ) \leq 0$$

$$ceq ( x ) = 0$$

$$A \cdot x \leq b$$

$$Aeq \cdot x = beq$$

$$lb \leq x \leq ub$$

where x, b, beq, lb, and ub are vectors, A and Aeq are matrices, c(x) and ceq(x) are function that return vectors, and g(x) is a function that returns a scalar. These types of generalized mathematical formulations have a number of well known computational solutions that have been implemented in a variety of programming languages. In our application the g(x), is likely some function of Cₜ. Further, the constraints on x could be related to an upper or lower bound on P, N, or f depending upon the objectives of the user and the selection of the independent variable. The x can be the principal amount of certain bonds, P, the notional amount of swaps and derivatives, N, or the structure of certain functions, f. A constraint could be related to annual debt service for each period of time per a revenue line such as the one shown in FIGS. 8-10.

The solutions to the above problem might result in one or more of the following:
the size of the structure or combinations of structures which minimize the selected risk statistic (N and/or P are the independent variables)
the size of the structure or combinations of structures which minimize the selected measure of expected cost (N and/or P are the independent variables)
the rate/price within the structure (the strike rate for an interest rate cap rate for instance) that achieves the selected risk or cost objective (f is the independent variable)
the rate specific amortization structure of the liability that minimizes Var[Cₜ] or similar risk measure over time and/or that minimize the selected measure of expected cost (P is the independent variable)

Linear optimization algorithms may be used to achieve various solution types as shown in the attached FIGS. 8-10, such as level, fill, deferred, or accelerated. However, unlike current technology that's standard in the industry, the solution now incorporates inclusion of derivatives and cash as well as cash flow risk measures for which targets can be set by the user.

The inventive system and method may be implemented in a variety of commonly available data processing systems (e.g. computers, computer networks, etc.) supplied with mathematical simulation and related software. By way of example, the inventive system and method may be implemented using the following exemplary components:
a computer including a memory, a processor and a graphical user interface;
input means coupled to said computer for inputting parameters, expectations, and constraints related to simulations of market variables and a financial structuring problem into said computer by the user including forecasts for distributions of market variables;
a monitor display coupled to said computer for displaying the resulting optimum financing structure;
said memory including:
   calculation means, operable by said processor, for calculating said simulation and resulting optimum financing structure;

During the inventive system operation, several software components which are both standard in the art and special to the inventive system and method) are loaded into the memory. These software components collectively cause the data processing system to function according to the methods of this invention. These software components are typically stored on mass storage. An operating system can be, for example, of the Microsoft Windows' family. Many high or low level computer languages can be used to program the analytic methods of this invention. Instructions can be interpreted during run-time or compiled. Preferred languages include C/C++, and JAVA®. Most preferably, the methods of this invention are programmed in mathematical software packages which allow symbolic entry of equations and high-level specification of processing, including algorithms to be used, thereby freeing a user of the need to procedurally program individual equations or algorithms. Such packages include Matlab from Mathworks (Natick, Mass.), Mathematica from Wolfram Research (Champaign, Ill.), or S-Plus from Math Soft (Cambridge, Mass.)

Thus, while there have been shown and described and pointed out fundamental novel features of the inventive system and method as applied to preferred embodiments thereof, it will be understood that various omissions and substitutions and changes in the form and details of the devices and methods illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. It is the intention, therefore, to be limited only as indicated by the scope of the claims appended hereto.

Thus, while there have been shown and described and pointed out fundamental novel features of the invention as applied to preferred embodiments thereof, it will be understood that various omissions and substitutions and changes in the form and details of the devices and methods illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. It is the intention, therefore, to be limited only as indicated by the scope of the claims appended hereto.

I claim:

1. A data processing method for determining at least one optimum financial liability structure, based on a plurality of financial data inputs, at least one financial factor, and at least one predefined constraint, comprising the steps of:
(a) providing the plurality of financial data inputs;
(b) providing at least one predefined constraint;
(c) identifying at least one stochastic financial factor from the at least one stochastic factor;
(d) assigning at least one predetermined distribution to said at least one stochastic financial factor; and
(e) determining the at least one optimum financial liability structure based at least in part on the plural financial data inputs, the at least one predefined constraint, and said at least one predetermined distribution.
